(19) United States
(12) Patent Application Publication
(10) Pub. No.: US 2010/0106550 A1
(43) Pub. Date: Apr. 29, 2010

(54) ACTIVITY POST AND SEARCH SYSTEM AND METHOD

(75) Inventor: Michael T. Duke, Monroe, NC (US)

Correspondence Address: Driggs, Hogg, Daugherty & Del Zoppo, 38500 Chardon Road, Willoughby Hills, OH, 44094, US

(73) Assignee: WACHOVIA CORPORATION, Charlotte, NC (US)

(21) Appl. No.: 12/257,202

(22) Filed: Oct. 23, 2008

(51) Int. Cl. G06Q 10/00; G06Q 50/00

(52) U.S. Cl. 705/9

(57) ABSTRACT

An activity assignment system is provided which establishes a ‘win-win’ environment benefiting both an employer as well as an employee. Generally, the innovation promotes professional development by providing mechanisms to promote volunteer opportunities within business units of an organization. By enabling employees to bid on intra- and inter-unit opportunities, these mechanisms promote cross-training and personal development.

### BACKGROUND

An individual's professional development is sometimes enhanced by knowledge beyond the scope of day-to-day employment activities and responsibilities. For example, cross-training which results in a better overall understanding of an organization contributes to an individual's professional development and employment satisfaction. Similarly, businesses benefit from employee's knowledge of the bigger picture in lieu of merely understanding their piece of the overall corporation.

Today, many corporations mandate rotational-type training programs that expose employees to different aspects and units within an organization. These rotations contribute to enhancing an employee's understanding of the corporation. As well, employees are able to get a ‘taste’ of different aspects of the corporation so as to be able to maximize their capabilities and interests. While many corporations employ rotational training programs, others permit individuals to cross-train in activities and assignments which are outside of their core responsibilities—in order to get exposure and expand knowledge. As described above, rotational training and cross-training programs benefit both the employee as well as the employer in many respects.

With regard to the employee, these programs improve performance while increasing job satisfaction, attitude and morale. Additionally, teamwork is encouraged throughout the organization. Still further, core skills and leadership skills are developed by improving communication between employees, their supervisors, and peers, both inter- and intra-departments.

With regard to the employer, these programs have been shown to improve employee retention, productivity and loyalty. Additionally, as described above, employee satisfaction is increased which reflects positively on the corporate environment, image and reputation.

Unfortunately, these programs are expensive and require a large amount administrative involvement which detracts from the benefits gained.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that can establish a ‘win-win’ environment which benefits both an employer (e.g., corporation) as well as an employee. Generally, the innovation promotes professional development by providing mechanisms to promote volunteer opportunities within and between business units of an organization. By enabling employees to bid on intra- and inter-unit opportunities, these mechanisms promote cross-training and personal development.

In another aspect of the subject innovation, the opportunities are ‘for-compensation’ opportunities rather than purely volunteer postings. Here, while the employees will be paid to engage in overflow and other projects, both the employee and the employer benefit from the enhanced training and productivity.

The overall innovation can be viewed as at least two sub-systems 1) activity post management system; and 2) activity bid management system. In operation, these management systems provide mechanisms by which intra- and inter-business unit opportunities can be posted for consideration and bid upon interest, respectively. Aspects require management approval prior to enabling or accepting bids from employees. As well, in other aspects, non-employees (e.g., retirees, vendors, job-seekers) can bid on the opportunities as desired or appropriate. As desired, bids can be ‘open’ so as to promote ‘bidding down.’ Similarly, to promote fairness, oftentimes, bids are ‘closed’ such that bidders are not aware of other's bidding particulars (e.g., amount of time, availability, experience).

In yet another aspect thereof, machine learning & reasoning components and mechanisms can be provided that employ a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example activity post and search system in accordance with aspects of the innovation.

FIG. 2 illustrates an example flow chart of procedures that facilitate posting available activities in accordance with an aspect of the innovation.

FIG. 3 illustrates an example flow chart of procedures that facilitate processing activity bids in accordance with aspects of the innovation.

FIG. 4 illustrates an example block diagram of an activity post management system in accordance with aspects of the innovation.

FIG. 5 illustrates an example block diagram of an activity bid management system in accordance with aspects of the innovation.

FIG. 6 illustrates an example block diagram of a bid interface in accordance with aspects of the innovation.

FIG. 7 illustrates an example block diagram of an assignment engine component in accordance with aspects of the innovation.

FIG. 8 illustrates an example block diagram of an activity bid management system that employs machine learning & reasoning (MLR) in accordance with aspects of the innovation.

FIG. 9 illustrates an exemplary procedure flow of posting and bidding on activities in accordance with aspects of the innovation.

FIG. 10 illustrates an exemplary procedure flow of processing activities in accordance with aspects of the innovation.

FIG. 11 illustrates an example welcome screen interface in accordance with the innovation.

FIG. 12 illustrates an example Web or network ‘Details’ interface in accordance with aspects of the innovation.

FIG. 13 illustrates an example Web or network ‘Discussion’ interface in accordance with aspects of the innovation.

FIG. 14 illustrates an example Web or network ‘Bidding’ interface in accordance with aspects of the innovation.

FIG. 15 illustrates a block diagram of a computer operable to execute the disclosed architecture.

FIG. 16 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

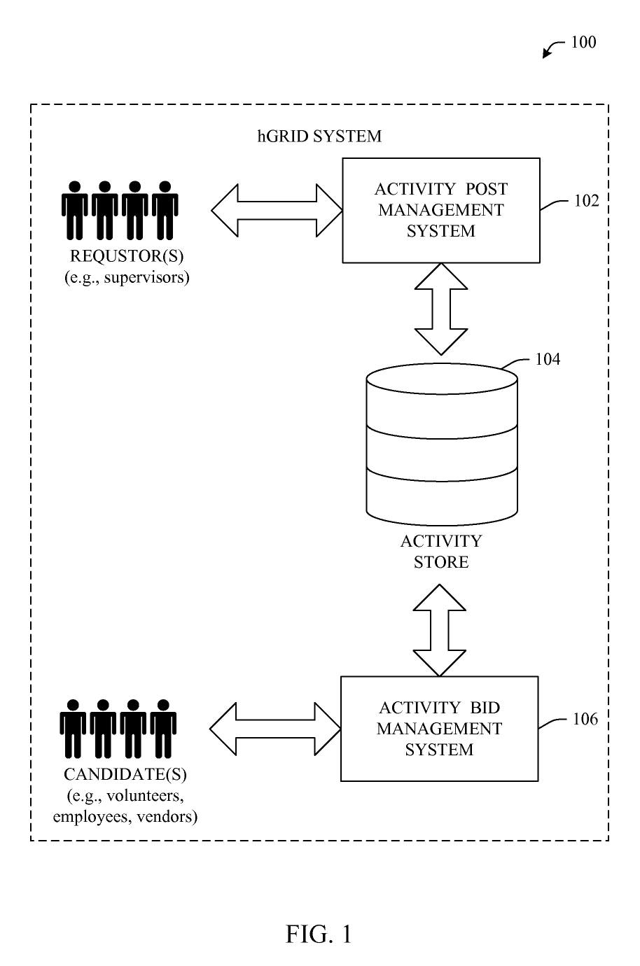

Referring initially to the drawings, FIG. 1 illustrates an ‘hGRID’ system 100 that promotes intra- and inter-unit collaboration in accordance with aspects. While the ‘hGRID’ name is used herein, it is to be understood that this name describes general functionality of the innovation and is not intended to limit the innovation in any manner.

The hGRID name is an acronym for Humans Getting Results In Days. The hGRID is a program that presents new opportunities for employees, e.g., IT (information technology) team members, in new and different areas (e.g., inter- and intra-business unit or departments). Team members and others can sign up (or bid) to use ‘extra cycles’ of time to advance projects for IT and its business partners. This participation can be based upon voluntary efforts with or without management approval. The term hGRID conveys the mobilization of resources (professionals) with available bandwidth to attend to critical or on-demand projects.

This hGRID innovation can be used both within an enterprise as well as in connection with external vendors or individuals that work on or otherwise would like to work on enterprise projects. Internal bids are most often ‘closed’ or ‘hidden’ while external bids are ‘open’ to support a bid-down process.

As illustrated in FIG. 1, the system 100 can include an activity post management system 102 that enables requestors (e.g., business unit managers/leaders) to post available activities into an activity store 104 for consideration by candidates (e.g., employees, vendors, students). In aspects, the activity store 104 can be a locally maintained store. Additionally, the store 104 can be a distributed store which includes business unit stores across the enterprise as a whole. Still further, the store can be a ‘cloud-based’ store as appropriate. It is to be understood that the store-configuration can be structured as appropriate and/or desired based upon most any factor or criteria including, but not limited to, security, availability of space, activity type, etc.

In accordance with the example system 100, the activity bid management system 106 facilitates candidates such as employees, vendors, etc. to bid on activities posted within the activity store 104. Most often, management approval is a prerequisite although, other aspects exist whereby approval is not a requirement of bidding for stored activities. As shown, in aspects, candidates such as volunteers can include employees and vendors of the enterprise. While the example described with regard to FIG. 1 is associated to a volunteer-based system, it is to be understood that other aspects can be structured that provide for-profit (e.g., cash, award points) mechanisms to make available overflow and other types of project activities within a corporation or entity. As well, it is to be appreciated that inter- and intra-enterprise opportunities can be posted for availability. In other words, the system 100 can be used to provide a repository of available activities based upon type of activity, theme, etc.

In an aspect, essentially, the activity bid management system 106 facilitates a pool of IT professionals to volunteer to take on timely, ad hoc work assignments. In doing so, the system 100 utilizes a time-bidding process, usually with management approval. Internally, the system 100 dynamics provide IT professionals with career-, networking- and knowledge-growth opportunities by enabling them to participate while, at the same time, improving IT efficiency and effectiveness. Externally, the innovation can be used to drive down vendor estimates—vendors must compete to win the work. As will be understood, employees have an opportunity to volunteer for projects that they might not usually have the opportunity to work on.

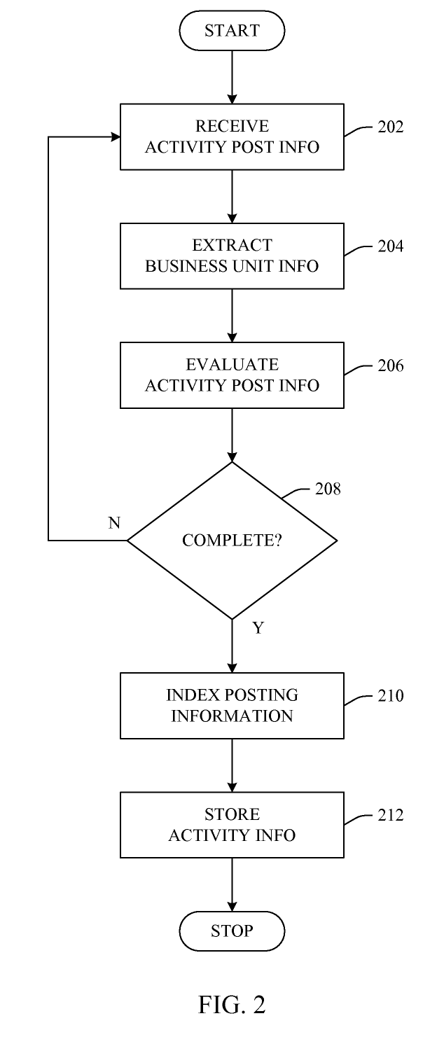

FIG. 2 illustrates a methodology of posting activities for consideration in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, activity post information is received. For example, as illustrated in FIG. 1, supervisors of business units can submit information that pertains to or describes an available activity. This information can include, but is not limited to, type of activity, business unit sponsor, supervisor sponsor, scope of activity, requirements for activity, etc. For example, a software coding project can be posted that requires particular baseline knowledge of a programming language. Similarly, the activity can be entered with a minimum commitment of time or duration.

Once received, the business unit particulars (e.g., name, supervisor) can be extracted at 204. Similarly, activity post information can be evaluated at 206. A decision is made at 208 to determine if the information provided is complete. For example, a determination is made to establish if all posting requirements are provided and complete. It will be understood that the posting requirements can vary based upon most any factor(s). If not complete, the methodology returns to 202 to solicit additional information regarding the proposed posting.

At 210, the activity information can be indexed or otherwise categorized. For example, activities can be grouped based upon type, requirements, time commitment, business unit or the like. At 212, the activity information can be stored, for example into an activity storage system (e.g., 104 of FIG. 1). In other aspects, a supervisor can add descriptive tags to a posting. It will be appreciated that these tags can provide additional factors upon which a participant (e.g., volunteer) can search.

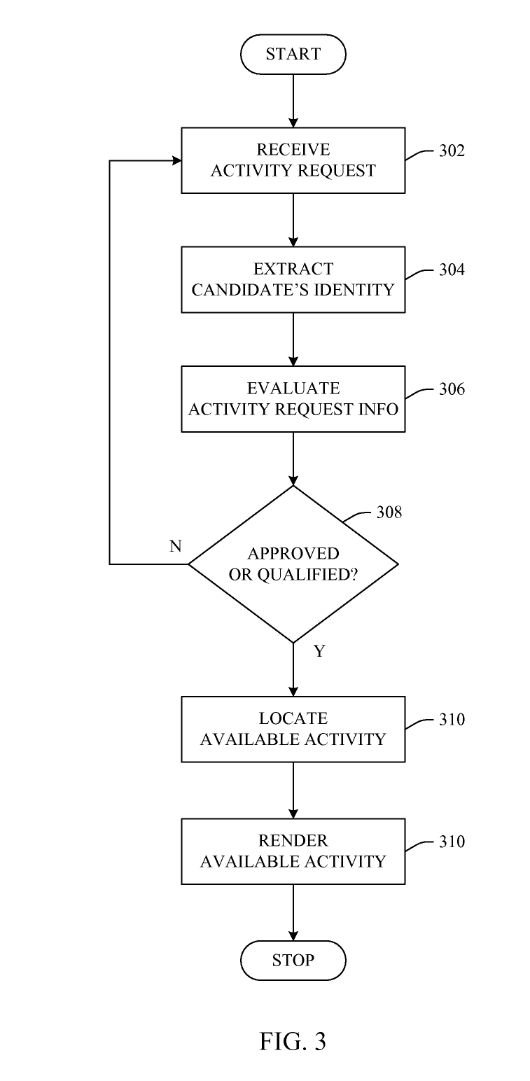

Referring now to FIG. 3, there is illustrated a methodology of processing an activity bid in accordance with the innovation. At 302, an activity request is received, for example from an internal employee, external vendor, external volunteer, etc. At 304, the candidate's identity is extracted from the information received. The activity request information is evaluated at 306—for example, based upon qualifications, availability, etc.

A determination is made at 308 to establish if the bidder is approved or qualified. For example, a determination can be made to establish if an employee has manager approval to participate. In other examples, manager (or supervisor) approval can be required prior to searching and bidding. If not approved or qualified, the methodology returns to 302 as shown.

At 310, an available activity (or group of activities) is located. For instance, activities can be located based upon search terms, tags, type, business unit, etc. At 312, available activities are rendered for consideration by the candidate. While the methodology of FIG. 3 encompasses searching for available activities, it is to be understood that bid criteria can be provided with regard to most any qualified of the rendered activities. The bidding process is described in more detail with regard to the figures that follow.

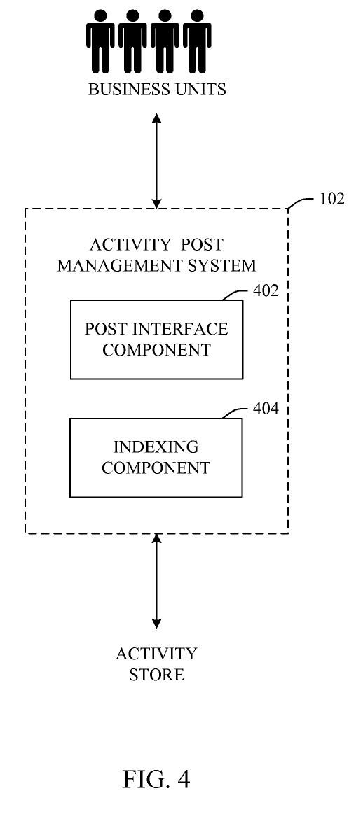

Turning now to FIG. 4, an example block diagram of an activity post management system 102 is shown. As illustrated, the system 102 can include a post interface component 402 and an indexing component 404. Together these sub-components (402, 404) are capable of facilitating the methodology of FIG. 2 as described supra. In other words, these sub-components (402, 404) provide mechanisms by which business units (e.g., supervisors, project managers) can post available activities. As further described above, these activities can be maintained within a store and thereafter browsed and bid upon by candidates (e.g., volunteers).

The post interface component 402 can provide a gateway such that individuals within business units can enter available activities. In aspects, the post interface component 402 can be a Web interface whereby supervisors (and others) can enter information representative of available activities directly for consideration by candidates. As described in FIG. 2, the information can be evaluated by the post interface component 402 prior to post within an activity store.

Accordingly, an indexing component 404 can be employed to apply indexing (and/or categorization) functionalities such that activity information can be efficiently searched, browsed, updated and/or deleted. For instance, activities can be indexed based upon most any criteria including but not limited to, business unit represented, due date, type of activity, level of commitment required, associated tags or the like.

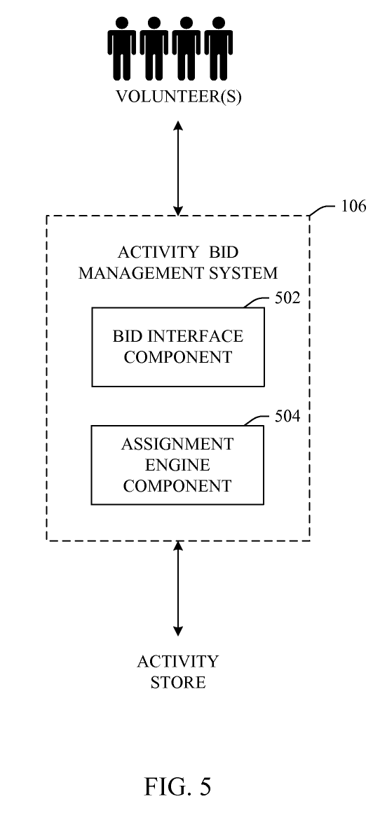

FIG. 5 illustrates an example block diagram of an activity bid management system 106. As shown, the activity bid management system 106 can include a bid interface component 502 and an assignment engine component 504. The bid interface component 502 enables qualified candidates to bid on available activities. For example, a ‘qualified’ candidate can represent a candidate having sufficient credentials and qualifications to engage the activity. Additionally, in most scenarios, the qualified candidate would have gained sufficient or appropriate management approval in order to be able to participate in the bidding program. The bid interface component 502 can be representative of most any interface including, but not limited to, Web-based interfaces (e.g., graphical user interfaces (GUIs)).

The assignment engine component 504 enables selection and/or approval of candidates based upon a particular activity or group of activities. Essentially, the engine component 504 provides means for location of activities that correspond to an individual's (e.g., volunteer's) request. In doing so, the engine component 504 can evaluate candidates as well as available activities in view of particular candidate information and/or credentials. Accordingly, the engine component 504 can associate successful candidates with particular activities.

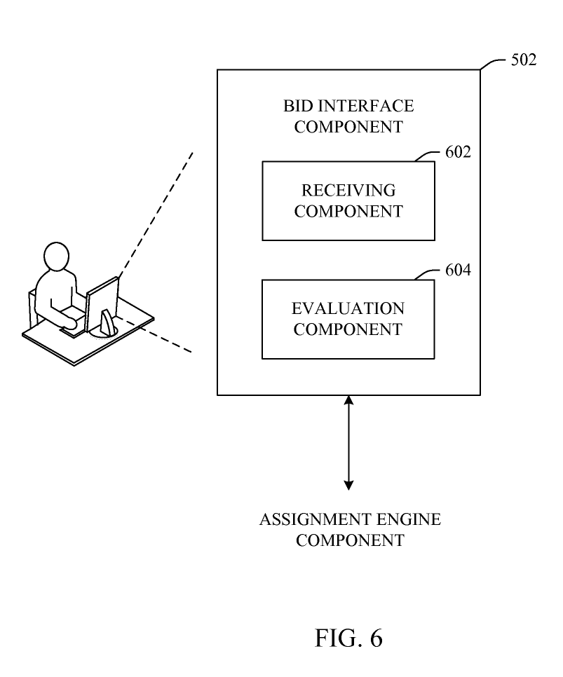

Referring now to FIG. 6, a block diagram of an example bid interface component 502 is shown. Generally, the bid interface component 502 can include a receiving component 602 and an evaluation component 604. Essentially, the sub-components (602, 604) provide mechanisms by which an individual can enter information for evaluation.

The receiving component 602 represents most any mechanism capable of receiving information, for example, a GUI. The evaluation component 604 is capable of assessing the completeness of information received from a candidate, e.g., a volunteer. For instance, the evaluation component 604 can assess the information so as to ensure accurate and complete information. In specific aspects, the evaluation component 604 can compare information received against previously stored candidate information for accuracy and/or veracity. It is to be understood that the aforementioned manager's approval can further enhance accuracy and truthfulness of candidates. In other words, in order for candidates to be permitted into the bidding process, a manager (or other supervisory member) could be required to ‘sign off’ or otherwise approve the candidate's credentials. Thus, in operation, as candidates bid on activities, their credentials can be compared against the previously approved credentials—as a result, effectiveness and accuracy of the system is enhanced.

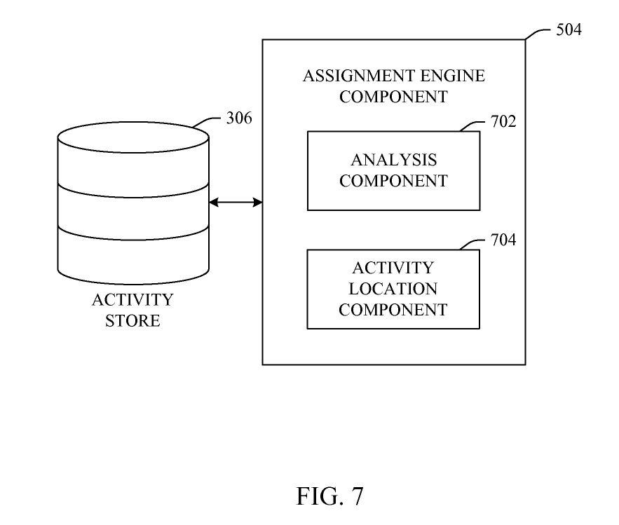

With reference now to FIG. 7, an example block diagram of an assignment engine component 504 is shown. Generally, the assignment engine component 504 is capable of analyzing an activity request, locating activities that meet the request and prompting logic based upon the request in view of activities and other potential candidates. Essentially, the assignment engine component 704 is capable of awarding an activity to a candidate.

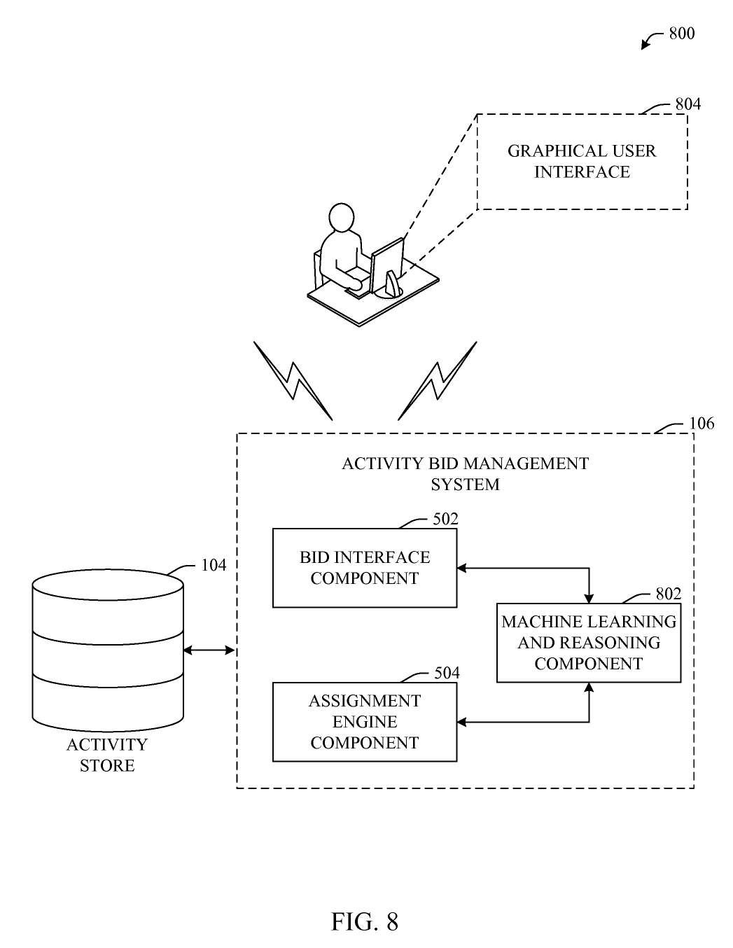

As described above, the assignment engine component 504 can include logic capable of evaluating an activity request. In particular aspects, this logic can be embodied within an analysis component 702. It will be understood that the analysis component 702 can employ most any logic including, but not limited to, rules-based logic and machine learning & reasoning (MLR). MLR-based logic will be described in greater detail with reference to FIG. 8 infra.

Based upon the request in view of a candidate's credentials, an activity location component 704 can be employed to access available activities which can be rendered to a user for consideration. In other words, the user can provide search criteria in the request which can be processed by the location component 704 to generate a set of activities appropriate for the particular candidate. In other aspects, the candidate capabilities need not be included within the request but rather mere preferences can be communicated in order to render available activities. Once activities are rendered, a candidate can bid on desired activities—the assignment engine component 504 is employed to effect the assignment of activities. While many of the aspects described herein are computer-implemented systems, it is to be understood that the features, functions and benefits of the innovation can also be implemented in a business method manner. These alternative aspects are to be included within the spirit and scope of the innovation.

FIG. 8 illustrates a system 800 that employs an MLR component 802 which facilitates automating one or more features in accordance with the subject innovation. The subject innovation (e.g., locating available activities, bidding on activities, assigning activities) can employ various MLR-based schemes for carrying out various aspects thereof. For example, a process for determining when to request or when to bid an available activity can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to search for available activities, when to bid on activities, what parameters to bid on activities, when to assign activities, etc.

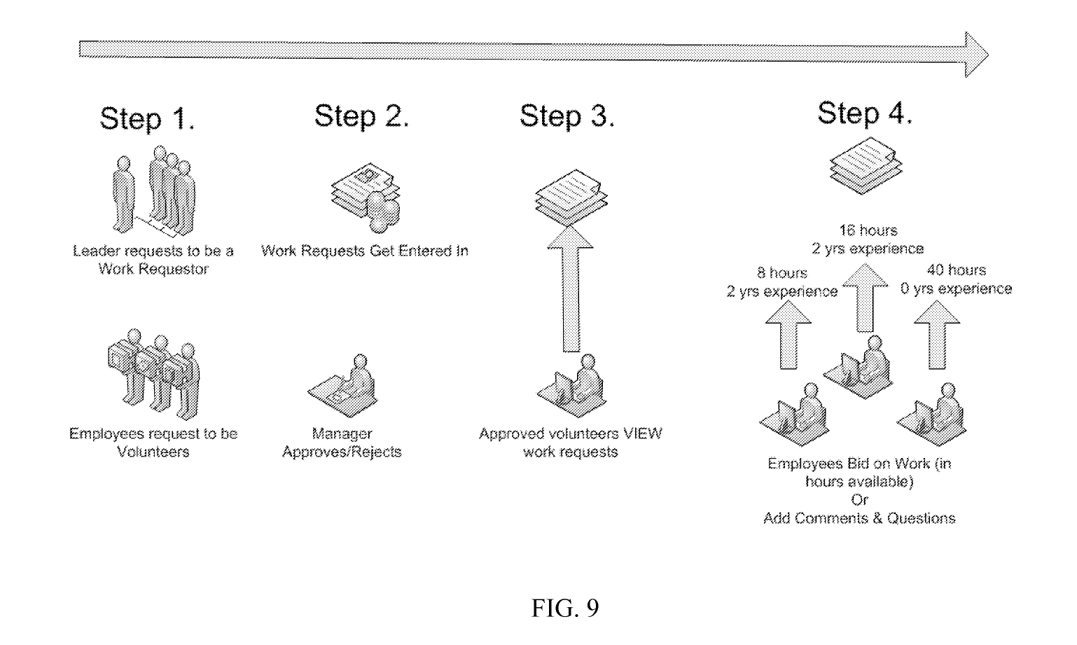

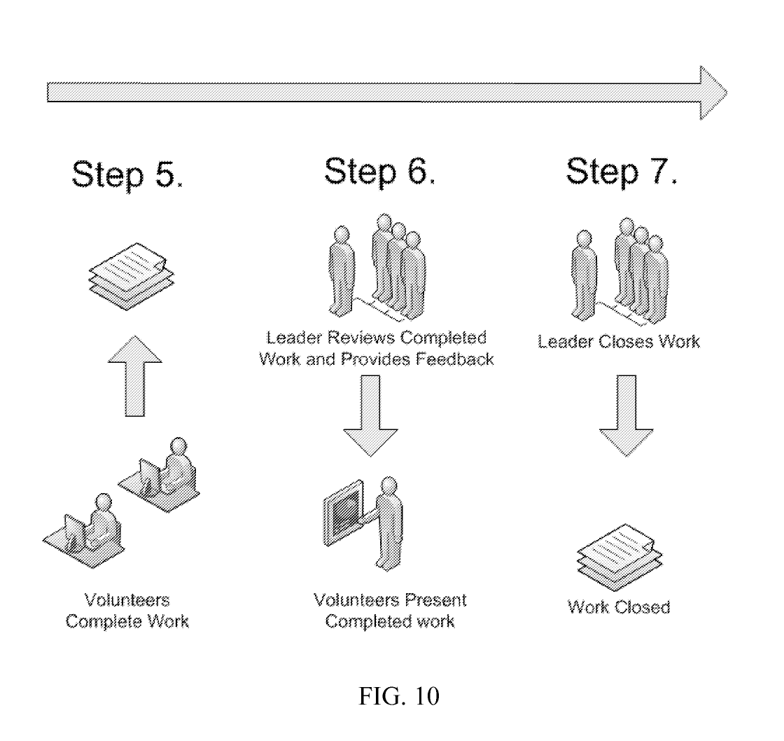

Turning now to FIGS. 9 and 10, an example process flow of procedures in accordance with the innovation are shown. Essentially, the process flow of FIGS. 9 and 10 illustrates how individuals within an organization interact to achieve activity assignment. As described above, although the process flow references ‘volunteers,’ it is to be understood that this is but one example of the innovation and that other aspects exist whereby the employees can obtain benefit (e.g., monetary, award points, recognition, professional development, etc.) without departing from the spirit and scope of the features, functions and benefits of the innovation. It is to be understood that, as with the methodologies described above, many of the steps of FIGS. 9 and 10 can occur in alternative orders as well as simultaneously. These alternative aspects are to be included in the scope of the innovation and claims appended hereto.

Commencing discussion at step 1, a leader requests to be a Work Requestor. Here, the leader can be a supervisor, manager, team leader, project manager, or the like. It is to be understood that the term ‘leader’ is not intended to be solely a hierarchical term. Rather, most any individual within an organization can request to be a Work Requestor. Similarly, individuals request to be permitted to bid on available activities. In one aspect, employees request to be ‘volunteers,’ for example, request approval from their immediate or other supervisor.

At step 2, approved leaders submit work requests. For instance, leaders submit activity requests which become available for bidders. With regard to employees ability to become a bidder (or volunteer), most often a manager will approve or reject a request. It will be appreciated that this approval/rejection can be based upon most any factor including, but not limited to, team workload, individual capabilities, forecasted workload, etc.

In step 3, interested approved volunteers can view work (or activity) requests submitted by leaders. Here, the volunteers can search and view pending or available activity requests. As described above, available activity requests can be queried based upon most any criteria such as volunteer credentials, requested completion, activity scope, requested bandwidth, etc.

Interaction with regard to available activities commences at step 4. For instance, employees can bid on work, for example, in available hours. Additionally, employees can ask questions or submit comments with regard to specific postings. As shown in FIG. 9, a bid can include hours available together with the amount of experience of a bidder. Additionally or alternatively, bidders can submit supplemental information that can enhance in the decision making and award process.

Turning now to FIG. 10, once activities are assigned, e.g., as a result of step 4, the volunteer completes the work at step 5. The completed work is reviewed by the leader(s) at step 6. Further, comments and feedback can be provided at step 6. Still further, as shown, employees can present their completed assignments or activities to the leader(s).

It will be understood that interaction can occur as well as modification to the activity if desired or appropriate. At step 7, the leader closes the activity and subsequently, the task is recorded as closed. The process flow of FIGS. 9 and 10 is intended to be exemplary and not limiting in any manner with regard to the features, functions and benefits of the innovation and claims appended hereto.

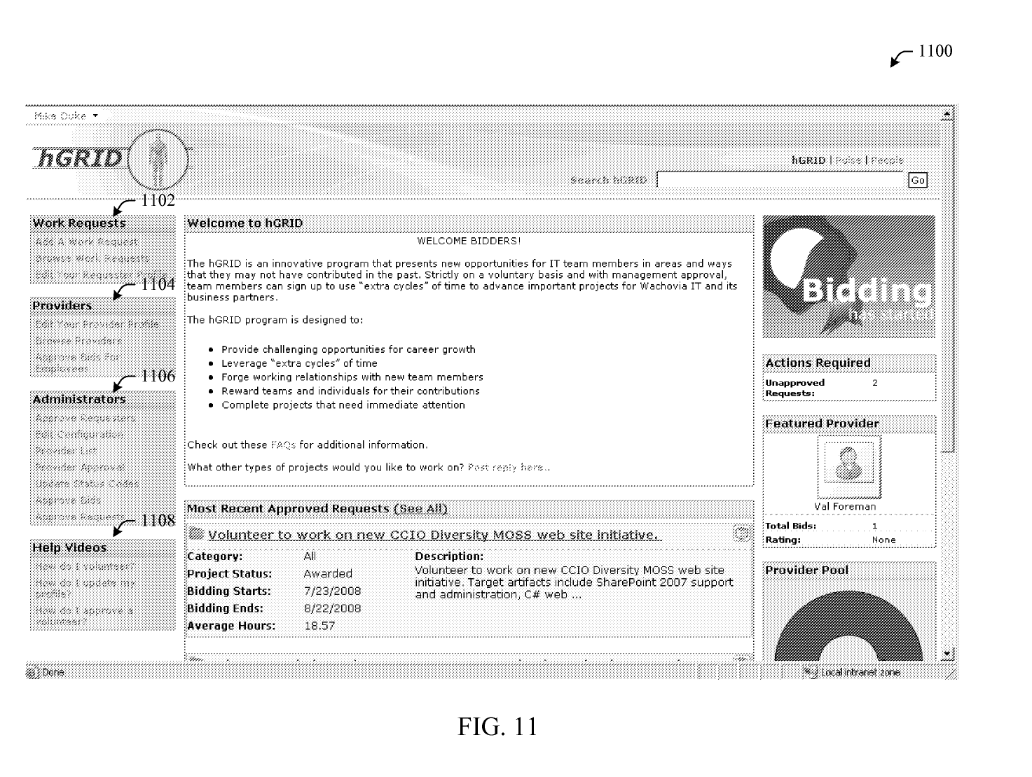

FIG. 11 is illustrative of an example welcome screen 1100 in accordance with the aforementioned system(s) and methodology(ies). As shown, the interface screen 1100 of FIG. 11 enables employees, providers and administrators to interact regarding work or activity requests. Generally, the system provides challenging opportunities for career growth of employees while leveraging ‘extra cycles’ of time. Additionally, the system assists in forging working relationships with new team members as well as members of other teams. Teams and members are rewarded for their contributions in a variety of ways, e.g., career development, networking/relationship building, experience, exposure, knowledge, monetary (if available), award points (if available), teamwork recognition, etc.

As can be seen on the left column 1102 of the interface screen 1100, work requests can be added or browsed by ‘clicking’ the appropriate link. It will be understood that that link, when activated (e.g., clicked, selected) will launch an appropriate action and subsequent screen interface. The requestor(s) can also modify their profile by selecting the last link of the Work Requests group 1102.

In the Provider's group 1104, providers (e.g., employees, candidates, partners, vendors) are able to edit profiles, browse providers as well as approve bids for employees or candidates. It will be understood that each of these options represent links that launch appropriate interfaces. Additionally, it is to be understood that, as described supra, the system can permit or accept bids from both internal as well as external providers as appropriate.

The Administrators group 1106 can be used to manage available activities. For example, requesters and providers can be approved. Additionally, requests and bids can be approved based upon most any defined or pre-defined criteria. Assistance with regard to the hGRID innovation can be offered at in the Help section 1108.

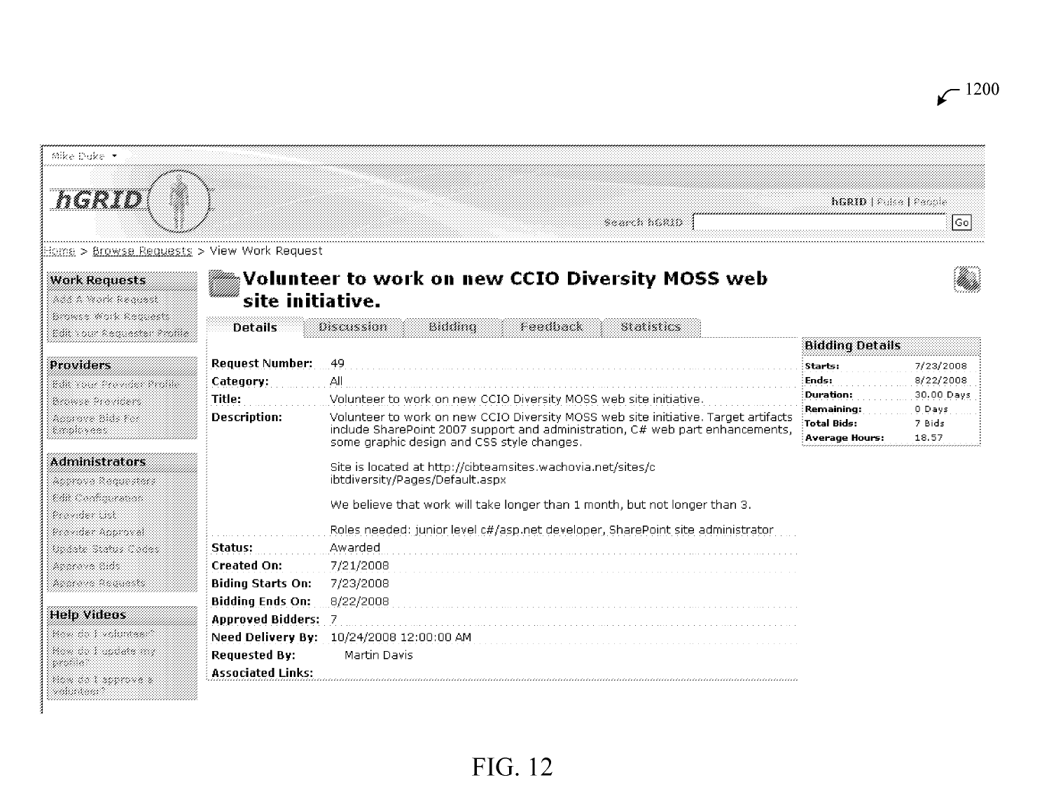

Turning now to FIG. 12, a screen shot 1200 of a Web interface is shown. As illustrated, this is an example view of a work request, “Volunteer to work on new CCIO Diversity MOSS website initiative.” The screen capture of FIG. 12 is the ‘Details’ tab that presents an overview of the activity. As shown, particulars can be presented to assist in managing the activity as well as soliciting qualified candidates. In addition to the title and description, timing of bids, awards, etc. can also be included.

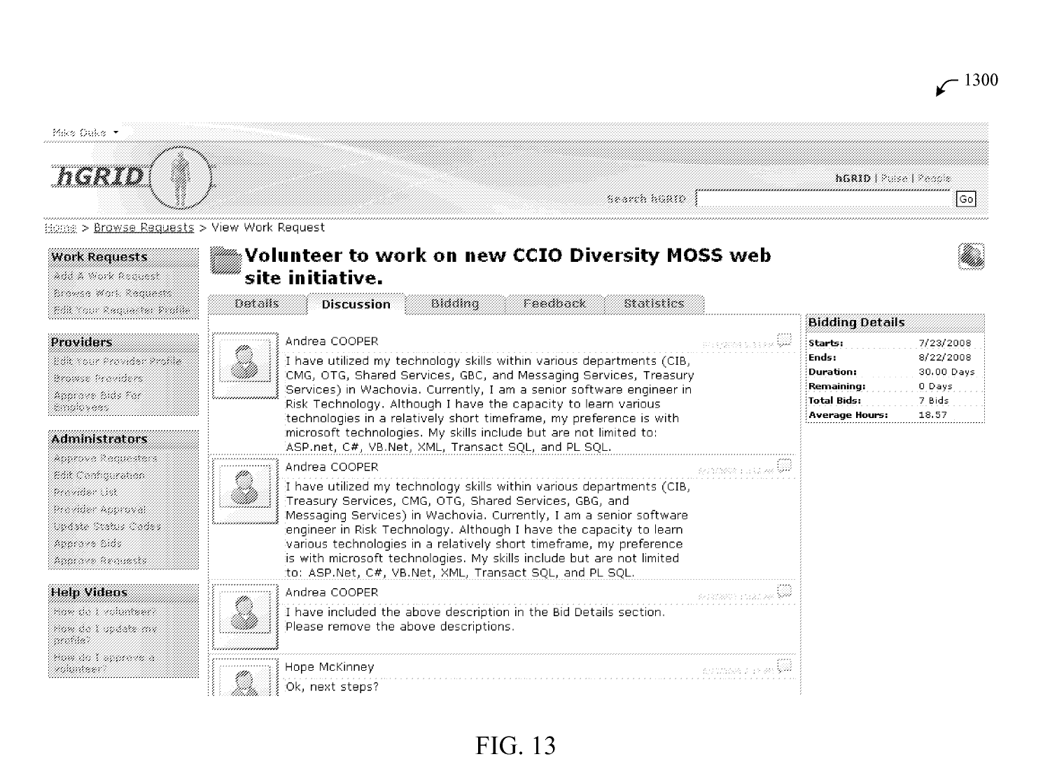

The screen shot 1300 of FIG. 13 illustrates an example Discussion with regard to the activity of FIG. 12. As shown, here, candidates can further express their interest and qualification in a particular activity. As well, questions and other comments can be tabled for discussion and/or clarification.

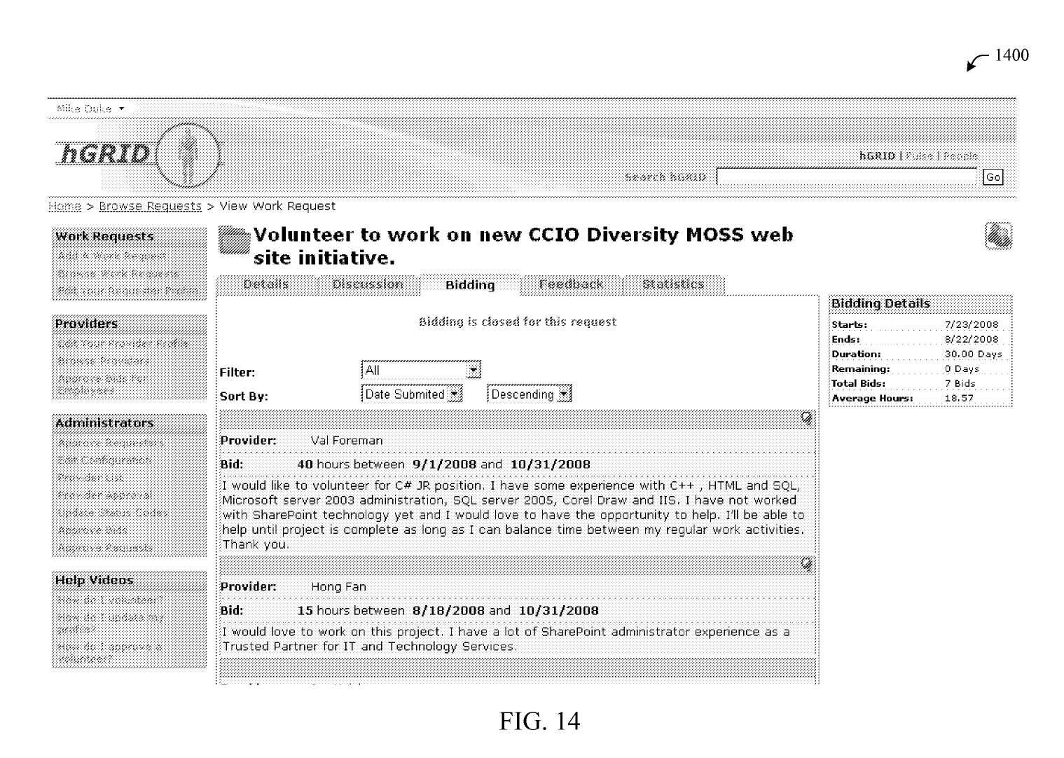

As described above, bids can be held ‘open’ or ‘closed’ as desired or appropriate. Most often, internal bids are held ‘open’ to encourage bidding. Continuing with the CCIO Diversity MOSS website initiative example, FIG. 14 illustrates an example Bidding screen shot 1400. As shown, two bids are shown. It will be appreciated that most any filtering and/or sorting parameters can be employed to enhance bidder review. As well, a reviewer can page through the Provider's bids as desired. Still further, Discussion, Feedback and Statistics with regard to the bids can be provided.

In accordance with aspects of the aforementioned systems, approval or award of an activity can be automated based upon most any defined or predefined criteria or rules. As well, if desired, manual selection can be effected based upon the providers' bids and associated credentials.

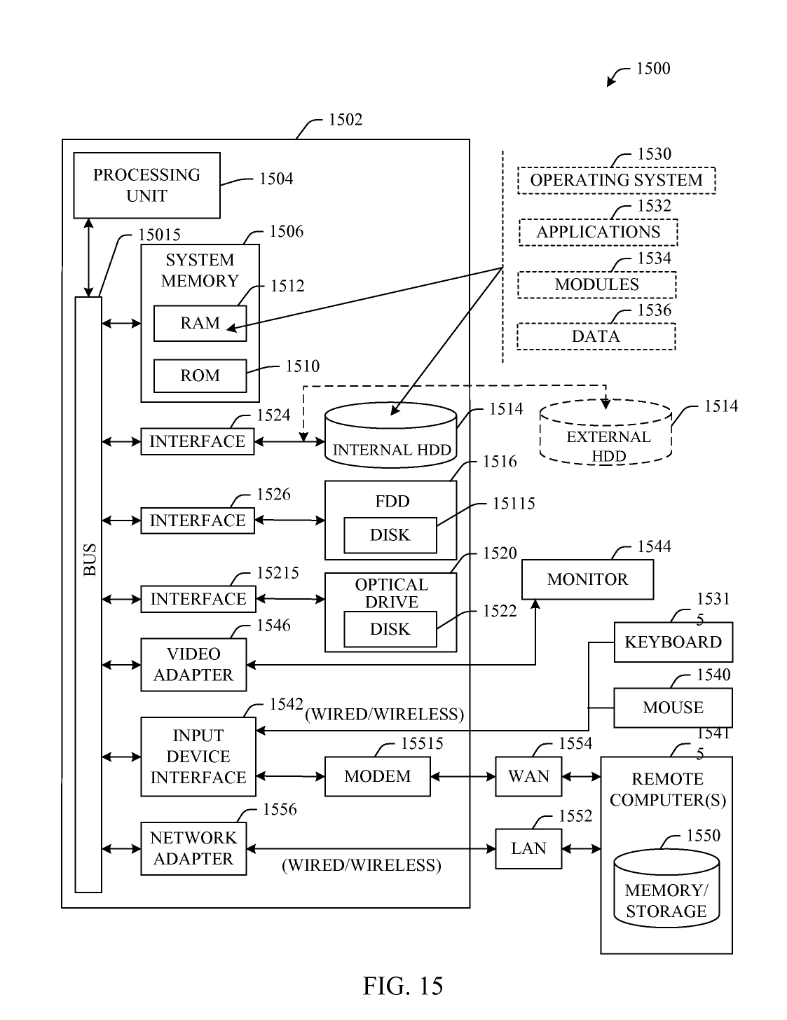

Referring now to FIG. 15, there is illustrated a block diagram of a computer operable to execute the disclosed architecture. In order to provide additional context for various aspects of the subject innovation, FIG. 15 and the following discussion are intended to provide a brief, general description of a suitable computing environment 1500 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 15, the exemplary environment 1500 for implementing various aspects of the innovation includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is appreciated that the innovation can be implemented with various commercially available operating systems or combinations of operating systems.

A user can enter commands and information into the computer 1502 through one or more wired/wireless input devices, e.g., a keyboard 1538 and a pointing device, such as a mouse 1540. Other input devices (not shown) may include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE 1394 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g., a wide area network (WAN) 1554. Such LAN and WAN networking environments are commonplace in offices and companies, and facilitate enterprise-wide computer networks, such as intranets, all of which may connect to a global communications network, e.g., the Internet.

When used in a LAN networking environment, the computer 1502 is connected to the local network 1552 through a wired and/or wireless communication network interface or adapter 1556. The adapter 1556 may facilitate wired or wireless communication to the LAN 1552, which may also include a wireless access point disposed thereon for communicating with the wireless adapter 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

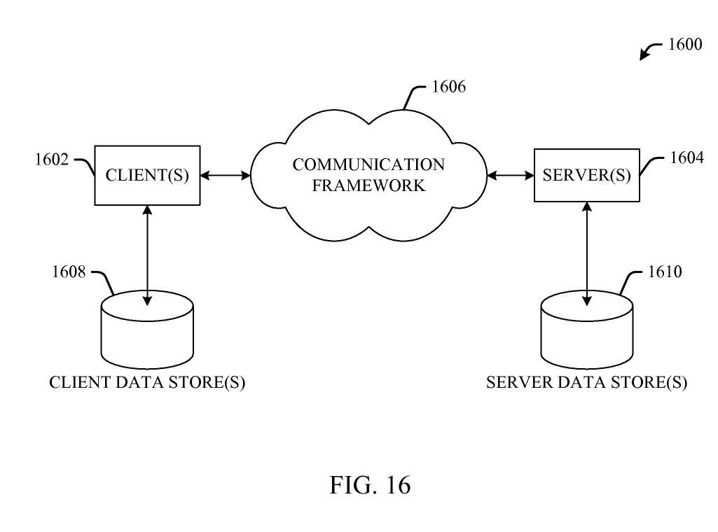

Referring now to FIG. 16, there is illustrated a schematic block diagram of an exemplary computing environment 1600 in accordance with the subject innovation. The system 1600 includes one or more client(s) 1602. The client(s) 1602 can be hardware and/or software (e.g., threads, processes, computing devices). The client(s) 1602 can house cookie(s) and/or associated contextual information by employing the innovation, for example.

The system 1600 also includes one or more server(s) 1604. The server(s) 1604 can also be hardware and/or software (e.g., threads, processes, computing devices). The servers 1604 can house threads to perform transformations by employing the innovation, for example. One possible communication between a client 1602 and a server 1604 can be in the form of a data packet adapted to be transmitted between two or more computer processes. The data packet may include a cookie and/or associated contextual information, for example. The system 1600 includes a communication framework 1606 (e.g., a global communication network such as the Internet) that can be employed to facilitate communications between the client(s) 1602 and the server(s) 1604.

Communications can be facilitated via a wired (including optical fiber) and/or wireless technology. The client(s) 1602 are operatively connected to one or more client data store(s) 1608 that can be employed to store information local to the client(s) 1602 (e.g., cookie(s) and/or associated contextual information). Similarly, the server(s) 1604 are operatively connected to one or more server data store(s) 1610 that can be employed to store information local to the servers 1604.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1 A system that facilitates activity participation, comprising:
an activity post management component that enables a plurality of work requesters to post a plurality of available activities for consideration; and
an activity bid management component that enables a plurality of candidates to submit bids on a subset of the available activities, wherein the bid management component awards each of the plurality of available activities based upon the bids.

2. The system of claim 1, further comprising a post interface component that facilitates each of the plurality of work requestors to post each of the plurality of available resources.

3. The system of claim 1, further comprising an indexing component that catalogs each of the plurality of work requests for retention into an activity store.

4. The system of claim 3, the activity store is at least one of a local store, distributed store or cloud-based store.

5. The system of claim 1, further comprising a bid interface component that enables each of the plurality candidates to review each of the plurality of available activities and to submit the bids.

6. The system of claim 5, further comprising:
a receiving component that collects each of the bids; and
an evaluation component that verifies management approval for each of the candidates.

7. The system of claim 1, further comprising an assignment engine component that evaluates bid criteria and awards each of the plurality of available activities based upon the bid criteria.

8. The system of claim 7, wherein the bid criteria includes candidate qualification information and available bandwidth information.

9. The system of claim 7, further comprising an analysis component that employs programmed logic to evaluate the bid criteria.

10. The system of claim 7, further comprising an activity location component that searches a store for the plurality of available activities based upon candidate qualifications.

11. The system of claim 1, further comprising a machine learning and reasoning component that employs at least one of a probabilistic and a statistical-based analysis that infers an action that a candidate desires to be automatically performed.

12. A computer-implemented method of assigning activities, comprising:
receiving a request for an available activity from a volunteer candidate;
evaluating the volunteer candidate based upon professional credentials and bandwidth; and
awarding or denying the available activity to the volunteer candidate based upon the evaluation.

13. The computer-implemented method of claim 12, further comprising confirming that the volunteer candidate is a manager-approved candidate.

14. The computer-implemented method of claim 12, further comprising searching a store for the available activity based at least in part upon one of type, scope, interest or qualifications.

15. The computer-implemented method of claim 14, further comprising rendering the available activity to the candidate, wherein the candidate decides whether to bid on the available activity based upon information in the rendering.

16. The computer-implemented method of claim 14, further comprising indexing and posting the available activity in the store.

17. A computer-executable system, comprising:
means for posting a plurality of available activities;
means for receiving requests from a plurality of candidates;
means for evaluating each of the requests; and
means for awarding each of the available activities based at least in part upon credentials of each of the plurality of candidates.

18. The computer-executable system of claim 17, further comprising means for indexing and storing the plurality of available activities.

19. The computer-executable system of claim 18, further comprising means for searching the plurality of available activities based upon candidate-defined criteria.

20. The computer-executable system of claim 19, wherein each of the plurality of candidates is manager-approved volunteer candidates.
